(19) United States
(12) Patent Application Publication
(10) Pub. No.: US 2006/0014454 A1
(43) Pub. Date: Jan. 19, 2006

(54) Scouring body and method for producing said body

(75) Inventor: Thomas Schindler, Friedberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: CARL FREUDENBERG KG, Weinheim (DE)

(21) Appl. No.: 10/539,783

(22) PCT Filed: Aug. 14, 2003
(86) PCT No.: PCT/EP03/09023

§ 371 Date: Jun. 17, 2005

(30) Foreign Application Priority Data
Dec. 19, 2002 (DE) 102 59 554.2

(51) Int. Cl. B32B 29/02; B32B 3/00

(52) U.S. Cl. 442/59; 156/290; 156/166; 156/178

(57) ABSTRACT

A scouring body includes a surface that has been embossed in a hot forming process. The body includes a textile consisting of woven or non-woven fibers, which is coated with a binding agent that has been thermally cured. At least some of the fibers are crimped, having in excess of 10 arcs per inch and a fiber length of at least 90 mm.

The present invention relates to a scouring body having a surface embossed by thermal molding and made of a textile material of woven or non-woven fibers which is coated using a binder hardened by a thermal treatment.

Such scouring bodies have working surfaces profiled by embossing and are in particular suitable and provided for cleaning and scouring processes. The scouring bodies may be connected to a support which may be another textile formation, a foam body, or a plastic body.

A binder is usually applied to a material web made of textile material for manufacturing these scouring bodies. The material web is then guided through a heating zone, where the binder hardens. The binder may be applied on one side or on both sides. The material web may be guided through a plurality of heating zones, the binder being first partially and subsequently fully hardened.

The embossing process for profiling the surface takes place with thermal molding following the final hardening of the binder. The embossing process may be carried out in a continuous process directly following the final hardening of the binder, or may also be carried out in a separate machine.

In particular when thermally hardening binder systems are used, thermal molding carried out after hardening for the purpose of embossing results in embrittlement, damage, and therefore weakening of the material. This damage is caused mostly by mechanical and/or thermal stresses in the binder. Therefore, the products obtained by this manufacturing process often do not resist the stresses occurring when they are used as cleaning or scouring bodies.

The object of the present invention is therefore to design a scouring body of the type named in the preamble in such a way that the material weakening occurring during the thermal molding for embossing the surface is reduced to a minimum.

This object is achieved according to the present invention by the fact that at least part of the fibers has a crimping of more than 10 arcs per inch and a fiber length of at least 90 mm.

The fiber length and fiber crimping have a decisive effect on the strength and durability of the textile material provided with the binder. Significant crimping of more than 10 arcs per inch supports the adhesion of the fibers to one another. A high fiber length of at least 90 mm stabilizes the embossed structures.

The scouring body thus obtained is suitable for use for cleaning and scouring purposes due to its higher strength, durability, and improved bonding of the fibers even after the embossing process, which unavoidably affects the binder. The use of long, highly crimped fibers not only compensates for the unavoidable damage to the binder during the embossing process, but also results in improved material properties compared to a material having shorter fibers and/or less crimped or non-crimped fibers.

According to a preferred embodiment of the present invention, the fiber length is greater than the distance of the repeating embossed structures on the surface. The fibers stabilize the embossed structures in this way.

Further advantageous features are the object of the additional subclaims.

The present invention also relates to a method for manufacturing a scouring body according to one of Patent Claims 1 through 10, a hardenable binder being applied, at least on one side, to a material web made from textile material having at least part of the fibers crimped with more than 10 arcs per inch and having a fiber length of at least 90 mm, and the material web being subsequently continuously guided through at least one heating zone.

Advantageous embodiments of the method are the object of the additional subclaims.

The present invention is elucidated below in detail with reference to the exemplary embodiments illustrated in the drawing.

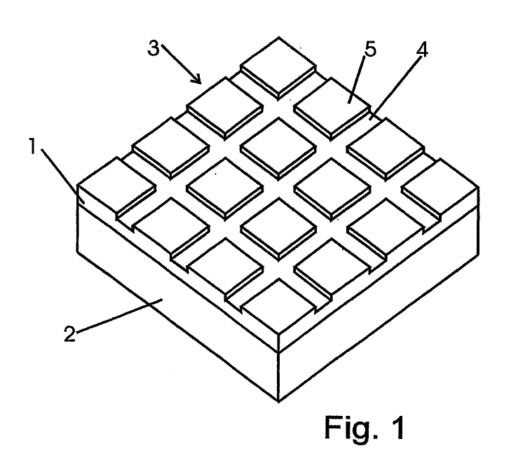

FIG. 1 shows a three-dimensional representation of a scouring body having an embossed surface, and

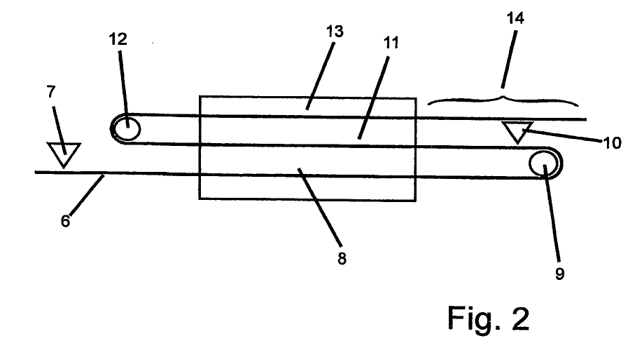

FIG. 2 schematically shows the process sequence of manufacturing a material web for producing scouring bodies according to FIG. 1.

Scouring body 1 illustrated in FIG. 1 is bonded to a support 2, for example a foam body. Scouring body 1 is made of a textile material of woven and non-woven fibers. In the exemplary embodiment depicted here, the proportion of fibers having a crimping of more than 10 arcs per inch and a fiber length of at least 90 mm is between 10% and 100% of the fibers of the textile material, for example 50%. The fiber thickness is between 1 dtex and 250 dtex, for example, 100 dtex.

The fibers are made of synthetic polymers, for example polyamide, polyester, polypropylene, and/or viscose. The fibers may also be made of natural fiber materials, such as cotton.

A typical scouring body, which is intended for use as a pot scourer, for example, may be made of fibers of a fiber mixture containing approximately 30% of a polyamide fiber having a thickness of 17 dtex, a crimping of approximately 12 arcs per inch, and a length of approximately 90 mm. This fiber mixture may additionally contain approximately 70% polyamide fibers having a thickness of approximately 17 dtex, a crimping of approximately 6 arcs per inch and a length of approximately 60 mm.

Surface 3 of scouring body 1, embossed by thermal molding, has an embossed structure which, in the exemplary embodiment depicted here, has a grid-like embossing 4 with square-shaped areas 5 without embossing in between.

The above-described textile material, which forms the base material for scouring body 1, is coated with a binder hardenable by thermal treatment.

FIG. 2 schematically depicts a typical manufacturing process of scouring body 1 according to FIG. 1.

A hardenable binder is applied, at least on one side and on both sides in the depicted exemplary embodiment, at a station 7 to a material web 6 made of textile material having at least a portion of fibers having a crimping of greater than 10 arcs per inch and a fiber length of at least 90 mm. The binder may be applied by spraying, spreading, padding, or in a bath.

The material web is subsequently guided continuously through a first heating zone 8, where the binder is partially hardened. Material web 6 then passes over a roller 9 and is turned over. At a second station 10, the binder is applied to the second side of the material web. The material web then passes through a second heating zone 11, where the binder applied at second station 10 is also partially hardened.

The material web travels, via a roller 12, to a third heating zone 13 where the binder is fully hardened. The web is embossed by thermal molding in a subsequent area 14, which is only schematically indicated in FIG. 2.

1-13. (canceled)

14. A scouring body comprising:
a textile material including woven or nonwoven fibers and having a surface embossed by thermal molding;
a binder coating the surface, the binder being thermally hardened, wherein at least a first portion of the fibers have a crimping of more than 10 arcs per inch and a fiber length of at least 90 mm.

15. The scouring body as recited in claim 14, wherein the embossed surface includes a plurality of repeating embossed structures, each separated by a distance and wherein the fiber length is greater the distance.

16. The scouring body as recited in claim 14, wherein the first portion of fibers includes between 10% and 100% of the fibers of the textile material.

17. The scouring body as recited in claim 14, wherein the first portion of the fibers have a thickness between 1 dtex and 250 dtex.

18. The scouring body as recited in claim 14, wherein the fibers include synthetic polymers.

19. The scouring body as recited in claim 18, wherein the fibers include at least one of a polyamide, a polyester, a polypropylene, and a viscose.

20. The scouring body as recited in claim 14, wherein the fibers include natural fiber materials.

21. The scouring body as recited in claim 20, wherein the fibers include cotton.

22. The scouring body as recited in claim 14, wherein the fibers include a fiber mixture containing approximately 30% polyamide fibers having a thickness of approximately 17 dtex, crimping of approximately 12 arcs per inch and a length of approximately 90 mm.

23. The scouring body as recited in claim 22, wherein the fiber mixture contains approximately 70% polyamide fibers having a thickness of approximately 17 dtex, crimping of approximately 6 arcs per inch and a length of approximately 60 mm.

24. A method for manufacturing a scouring body, the method comprising:
providing a a material web made of textile material including woven or non-woven fibers, at least a portion of the fibers having crimping of greater than 10 arcs per inch and a fiber length of at least 90 mm;
applying a hardenable binder to at least one side of the material web; and
continuously guiding the material web and the hardenable binder through a heating zone.

25. The method as recited in claim 24, wherein the applying of the binder is performed using at least one of spraying, spreading, padding, and via a bath.

26. The method as recited in claim 24, wherein the applying of the binder is performed to a first side of the material web and further comprising applying a further binder to a second side of the material web and then guided the web, the binder and the further binder through at least one further heating zone.
